(19) United States
(12) Patent Application Publication
(10) Pub. No.: US 2025/0290538 A1
(43) Pub. Date: Sep. 18, 2025

(54) SELF-CRIMPING NUT

(71) Applicant: Fox Factory, Inc., Duluth, GA (US)

(72) Inventor: Ivan Tong, JR., Odenton, MD (US)

(73) Assignee: Fox Factory, Inc., Duluth, GA (US)

(21) Appl. No.: 18/607,922

(22) Filed: Mar. 18, 2024

(51) Int. Cl. F16B 39/34; F16B 37/04

(52) U.S. Cl. CPC F16B 39/34; F16B 37/048

(57) ABSTRACT

A damper apparatus, assembly, and method of manufacturing are disclosed herein. A piston with a counterbore comprising a chamfer located in a recessed portion of the counterbore can be included. A self-crimping nut can include an inner diameter that comprises a threaded surface to fasten the self-crimping nut to a shaft. A first portion of the self-crimping nut along a distal edge of said axial length can be configured to contact the chamfer piston and deform when fastened to the shaft at a specified torque value to prevent the self-crimping nut from becoming unfastened.

### FIELD OF THE INVENTION

Embodiments of the invention generally relate to a self-crimping nut for a shock assemblies.

### BACKGROUND

Shock assemblies (e.g., dampers, shock absorbers, etc.) are used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force can be significantly reduced or even absorbed completely before it is transmitted to a person on a seat of the vehicle. However, depending upon the terrain being traversed, it can be valuable to be able to change the amount of shock absorption provided by the shock assembly for personal comfort, vehicle performance, and the like.

### BRIEF DESCRIPTION OF THE DRAWINGS

Aspects of the present invention are illustrated by way of example, and not by way of limitation, in the accompanying drawings, wherein:

FIG. 1 is a perspective view of a vehicle having a front and rear damper piston assembly, in accordance with an embodiment.

FIG. 2 is a perspective view of damper piston assembly with a crimping nut, in accordance with an embodiment.

FIG. 3A is a cross-sectional view of a damper piston assembly with a self-crimping nut, shown in accordance with an embodiment.

FIG. 3B is an enlarged cross-sectional view of a damper piston assembly with a self-crimping nut, shown in accordance with an embodiment.

FIG. 4A is a cross-sectional view of a damper piston assembly with a self-crimping nut, shown in accordance with an embodiment.

FIG. 4B is an enlarged cross-sectional view of a damper piston assembly with a self-crimping nut, shown in accordance with an embodiment.

FIG. 5 is a three-dimensional view of a self-crimping nut with relief portions, shown in accordance with an embodiment.

FIG. 6 is flowchart for a method of manufacturing a damper piston assembly with a self-crimping nut, shown in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

In general, a suspension system for a vehicle provides a motion modifiable connection between a portion of the vehicle that is in contact with a surface (e.g., an unsprung portion) and some or all of the rest of the vehicle that is not in contact with the surface (e.g., a suspended portion).

Components of a damper piston assembly or a damper apparatus can include a piston, a shaft, and a nut. The nut can be fastened to the shaft where the shaft protrudes through an opening in the piston. The nut fastens the damper piston assembly or apparatus together. During operation or riding, vibrations can cause the nut to come loose. Crimping the nut after fastening can prevent the nut from becoming loose or falling off due to the vibrations.

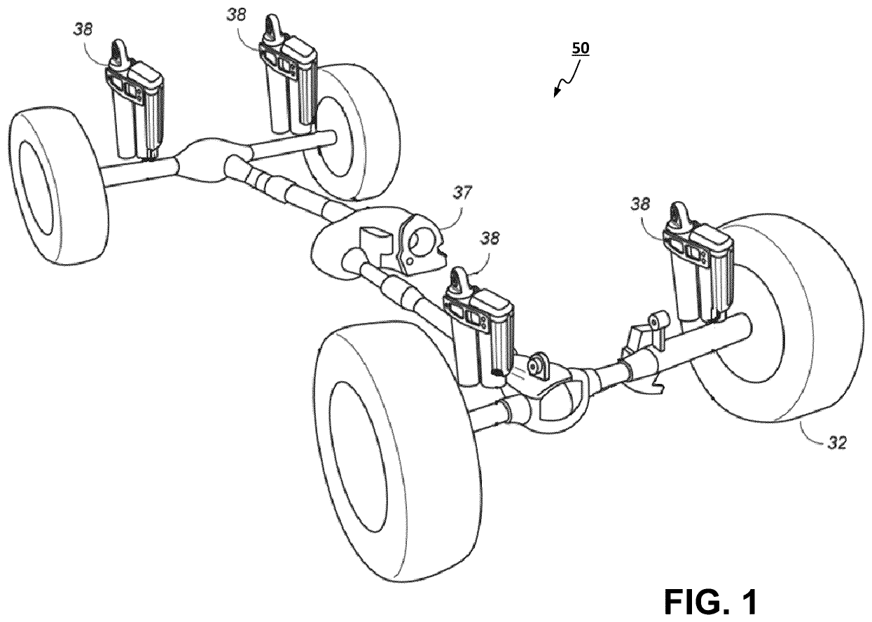

Referring now to FIG. 1, a perspective view of a vehicle 50 having at least one shock assembly 38 with a piston damper is shown in accordance with an embodiment. Although a wheeled vehicle 50 is used in the discussion, the at least one wireless electronic shock assembly 38 disclosed herein is also suited for use in other vehicles such as, but not limited to a bicycle, an electric bike (e-bike), a hybrid bike, a scooter, a motorcycle, an ATV, a personal water craft (PWC), a vehicle with three or more wheels (e.g., a UTV such as a side-by-side, a car, truck, etc.), an aircraft, a snow machine, and the like. In one embodiment, the shock assembly 38 with dampers is also suited for use in suspension inclusive devices such as, but not limited to, an exoskeleton, a seat frame, a prosthetic, a suspended floor, a door opening/closing damper, a lift assist damper, or any other application where a controlled compression and/or rebound of a suspension/damper is desired. However, in the following discussion, and for purposes of clarity, a 4-wheeled vehicle 50 is utilized as the example vehicle upon which the at least one wireless electronic shock assembly 38 is shown and described.

In one embodiment, vehicle 50 is a generic vehicle such as a car, truck, side-by-side, or the like driven by an engine and consisting of an unsprung portion (such as tires 32, drive train 37, axles, etc.), a sprung portion (such as a cockpit, seating area, etc.), and a suspension including at least one wireless electronic shock assembly 38 to couple the sprung portion of the vehicle with the unsprung portion.

### Crimping Nut

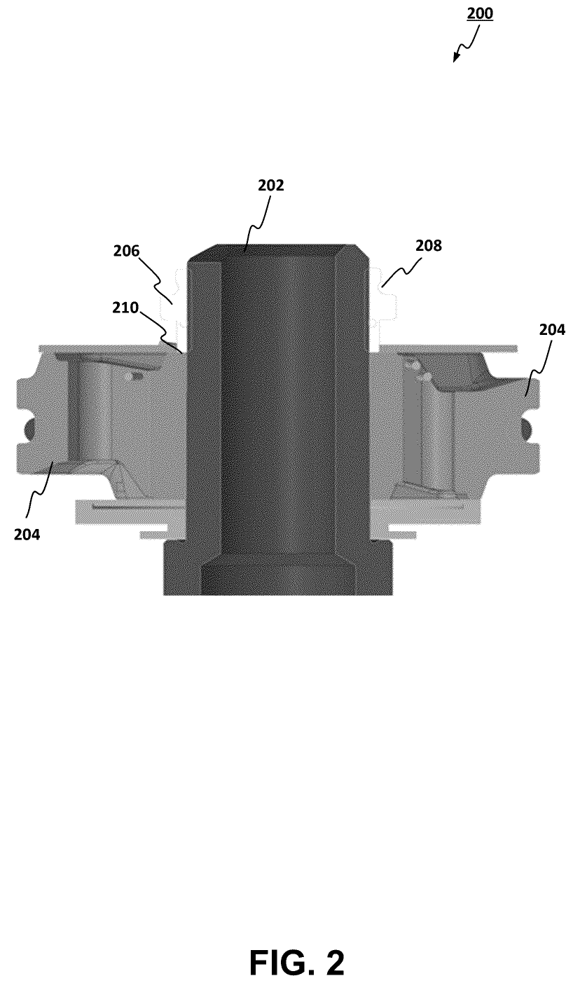

With reference now to FIG. 2, a cross-section view of a damper piston assembly 200 is shown in accordance with one embodiment. The damper piston assembly 200 includes a shaft 202, a piston 204, and a crimp nut 206. It should be appreciated that the crimp nut 206 is not a self-crimping nut of the present technology. Rather the crimp nut 206 is designed to be installed and fastened, then crimped after fastening. Such an embodiment employs a crimping tool and a crimping installation step to properly install and crimp the crimp nut 206. The groove 208 in the crimp nut 206 depicts a deformation in the crimp nut 206 after crimping has occurred.

The crimp nut 206 engages with a surface 210 of the piston 204 for fastening purposes. With the groove 208 being formed after the crimp nut 206 is installed, the crimp tool deforms a portion of the threads of the crimp nut 206 into a threaded surface on the shaft 202. Therefore, the crimp tool accesses exposed portion of the crimp nut 206 at the groove 208. Therefore, this technique crimps the threads of the crimp nut 206 onto the shaft 202 at a portion of the shaft 202 that extends above the surface 210 of the piston 204. This technique is not able to crimp the crimp nut 206 in a region that is below the surface 210 that is inside of a counterbore of the piston 204. Embodiments of the self-crimping nuts of the present technology are able to overcome this limitation of the crimp nut 206 and are able to crimp the self-crimping nut below the surface 210. This can allow for different shapes of self-crimping nuts that can improve designs for shim stacks and the overall design of the damper piston assembly. The self-crimping nuts of the present technology can also be installed without the use of a crimping tool and without a crimping step that is in addition to the fastening step. In other words, the self-crimping nut is crimped via the fastening step when the self-crimping nut is installed at a specified torque value that causes a portion of the self-crimping nut to deform.

### Self-Crimping Nut

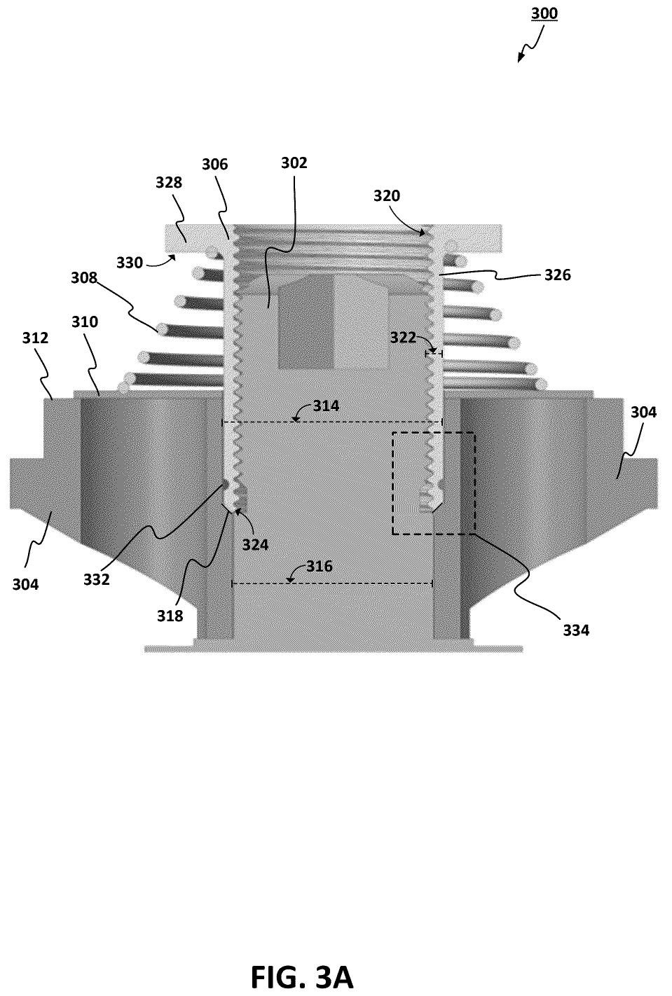

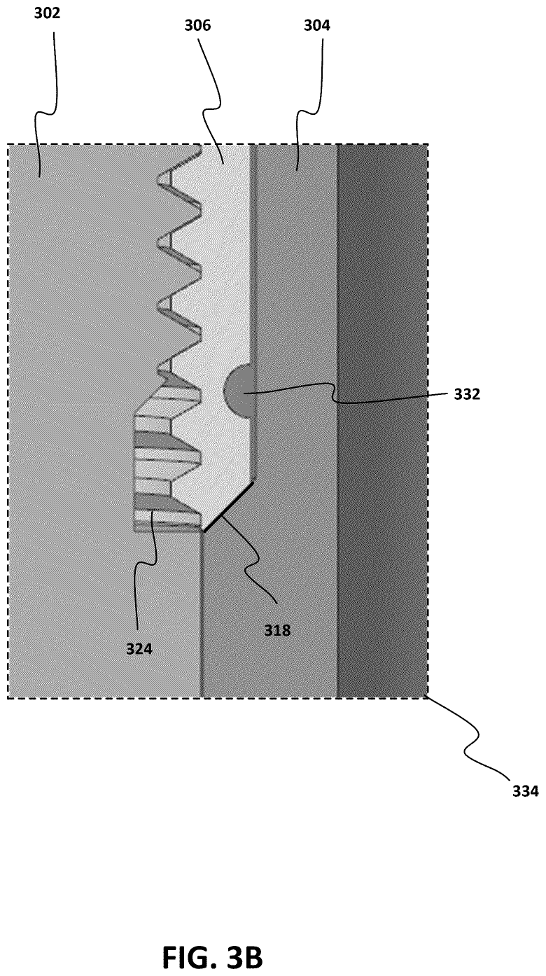

With reference now to FIG. 3A, a cross-section view of a damper piston 300 is shown in accordance with one embodiment. In one embodiment, the damper piston 300 can be a component of the shock assembly 38 of FIG. 1. The damper piston 300 includes a shaft 302, a piston 304, and a self-crimping nut 306. A damper apparatus can also include components of the damper piston 300. The damper piston assembly can also include a shim stack or shim stack assembly. A shim stack can include components such as a helical coil 308, a shim 310, a plurality of shims, etc. The damper piston 300 can be part of any type of suspension. In one embodiment, the shaft 302 is an end of a damper piston shaft and can be substantially cylindrical in shape and may include a threaded outer surface designed to fasten to a corresponding object.

In one embodiment, the piston 304 can include an opening that may be cylindrical in shape. The opening can be referred to as a counterbore. The counterbore can allow the shaft 302 to pass through the piston 304. The counterbore can be referred to as a recessed portion of the piston 304. A portion of the axial length of the shaft 302 can extend above or beyond the surface 312 of the piston 304 as depicted. The counterbore can have a first diameter 314 and a second diameter 316. A chamfer 318 can be formed to bridge the distance between the first diameter 314 and the second diameter 316. When viewed in three dimensions the chamfer 318 can resemble a funnel and can surround a portion of the counterbore of the piston 304 in a ring shape. The chamfer 318 can be at an angle relative to the axial length of the shaft 302. The shaft 302 and the piston 304 can be formed such that a surface of the shaft 302 is in contact with the piston 304 in the region where the piston has the second diameter 316, as is depicted, and formed with a gap between the threaded surface of the shaft 302 and the region of where the counterbore of the piston 304 has the first diameter 314. In one embodiment, the first diameter 314 and the second diameter 316 may be equal in length and the shaft 302 or a threaded portion of the shaft 302 may be narrower than the first diameter 314 and the second diameter 316.

The self-crimping nut 306 can be formed in a cylindrical shape with a hollow portion extending through the axial length of the self-crimping nut 306 such that the self-crimping nut 306 has an inner diameter and an outer diameter. This may be described as a ring shape or a sleeve shape. The inner diameter of the hollow portion of the self-crimping nut 306 can be a threaded surface 320. The self-crimping nut 306 between the inner diameter and outer diameter can have a thickness 322. The self-crimping nut 306 can be formed such that a portion of the thickness 322 of the shaft can fit into the gap between the piston 304 and the shaft 302 at the first diameter 314, as is depicted. A first portion 324 of the outer diameter of the shaft of the self-crimping nut 306 can contact the chamfer 318 of the piston 304 along a distal edge of the self-crimping nut 306. The self-crimping nut 306 can be installed or fastened via the thread surface 320 engaging with the threaded surface of the shaft 302. Fastening the self-crimping nut 306 to the shaft 302 causes the contact and engagement of the first portion 324 with the chamfer 318. Torquing the self-crimping nut 306 to a specified torque value causes the first portion 324 to deform against the chamfer 318 and crimp into the threaded surface of the shaft 302. In such an embodiment, the crimp is located beneath the surface 312 of the piston 304. The crimp of the self-crimping nut 306 deforms into the threaded surface of the shaft 302 and can prevent the self-crimping nut 306 from coming loose or falling off due to vibrations while the damper piston 300 is in operation such that the piston 304 doesn't fall off of the shaft 302. A portion of the outer diameter of the self-crimping nut 306 can also contact the piston 304 at the first diameter 314. In one embodiment, the self-crimping nut 306 is composed of a material that is ductile and can deform to cause the crimp.

In one embodiment, a second portion 326 of the self-crimping nut 306 can extend beyond or above the surface 312 of the piston 304 to allow the piston 304 to, for example, move with respect to the end of the shaft 302, change a shim stack preload, and the like. The second portion 326, or proximal end, of the self-crimping nut 306 can also extend beyond and above the shaft 302 as is depicted. In one embodiment, a third portion 328 can be located at the proximal end of the self-crimping nut 306. The third portion 328 can extend laterally away from and substantially perpendicular to the axial length of the self-crimping nut 306 such that the cross-section view of the self-crimping nut 306 forms a T shape as is depicted. The third portion 328 can be formed into a shape that engages with a fastening device such as a wrench. For example, the third portion 328 can be formed into a hexagonal shape. The third portion 328 can also include a surface 330 that is substantially perpendicular to the axial length of the self-crimping nut 306 and faces the surface 312 of the piston 304. The shim stack with the component parts such at the helical coil 308 and the shim 310 can be compressed between the surface 330 of the self-crimping nut 306 and the surface 312 of the piston 304 once the self-crimping nut 306 has been fastened to the shaft 302. The form of the third portion 328 of the self-crimping nut 306 can allow for various designs of the shim stack. It should be noted that the shim stack is used to provide resistance to oil flow through the piston. Additionally, numerous variations can be made to the shim stack to vary the fluid/oil resistance provided by the shim stack. Such shim stack changes include, but are not limited to, changing the number of shims, changing the thickness and/or rigidity of the shims, changing the manner in which the shims are stacked, altering the preloading of the shim stack, and the like.

In one embodiment, the self-crimping nut 306 can include a relief portion 332. The relief portion 332 can be included to provide a breaking or bending area for the self-crimping nut 306 to deform and crimp. The damper piston 300 depicts the relief portion 332 as a groove that extends radially around the outer diameter or circumference of the shaft of the self-crimping nut 306. The groove can be a semi-circular shape with a diameter or any other suitable shape. The size of the groove, meaning the size of the diameter can be changed based on the flexibility of the material that the self-crimping nut 306 is composed of. For example, if the self-crimping nut 306 is composed of a material that easily deforms, the diameter of the semi-circular groove can be smaller as compared to a harder material. The relief portion 332 can be optional and may not be included in all embodiments. The specified torque value to deform the self-crimping nut 306 upon installation can be changed based on the material that the self-crimping nut 306 is composed of and based on the presence, absence, type of material, and/or size of the relief portion 3332 or based on the material of an end of shaft 302. In one embodiment, the self-crimping nut 306 can be removed from the shaft 302 and the piston 304 after the self-crimping nut 306 has been fastened and crimped. To remove the self-crimping nut 306, a sufficient amount of torque can be applied in a direction opposite of the fastening direction. During removal of the self-crimping nut 306, a portion of the crimped material may break away from the self-crimping nut 306. The portion of material that broke away can be removed from the damper piston assembly, may come out when oil is drained from the suspension, and/or when piston 304 is removed from the end of shaft 302. The self-crimping nut 306 may be removed to service or repair the damper piston assembly. The self-crimping nut 306 may or may not be reusable after being installed and then removed from the damper piston assembly.

Optional relief portions 334 is depicted in FIG. 3A. FIG. 3B depicts an enlarged view of optional relief portions 334 of FIG. 3A. The enlarged view clearly depicts the first portion 324 that has been deformed after contacting the chamfer 318 as well as depicting the relief portion 332.

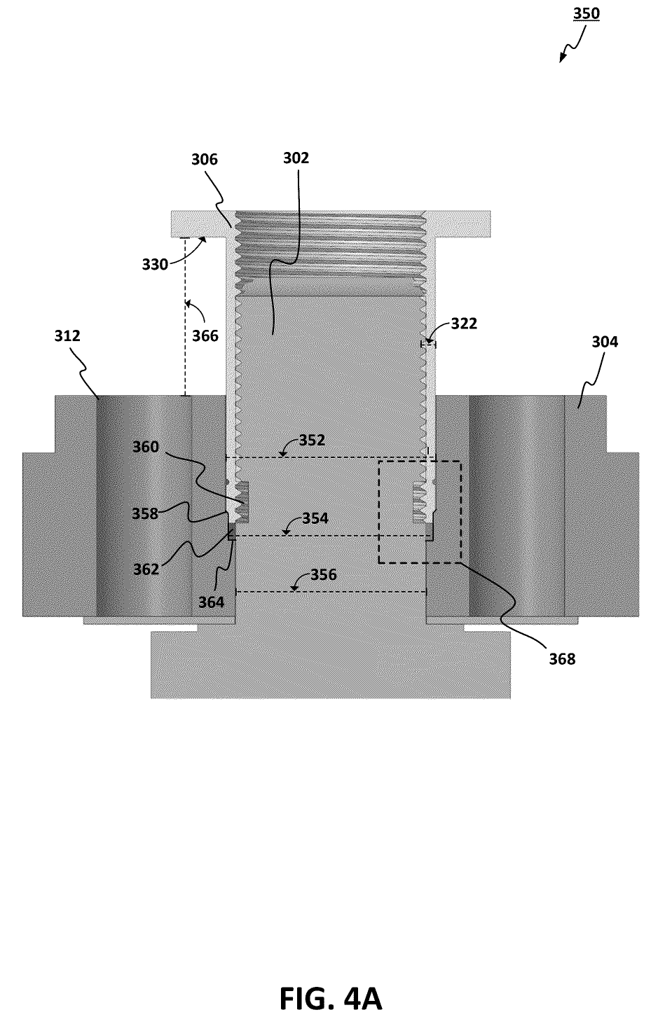

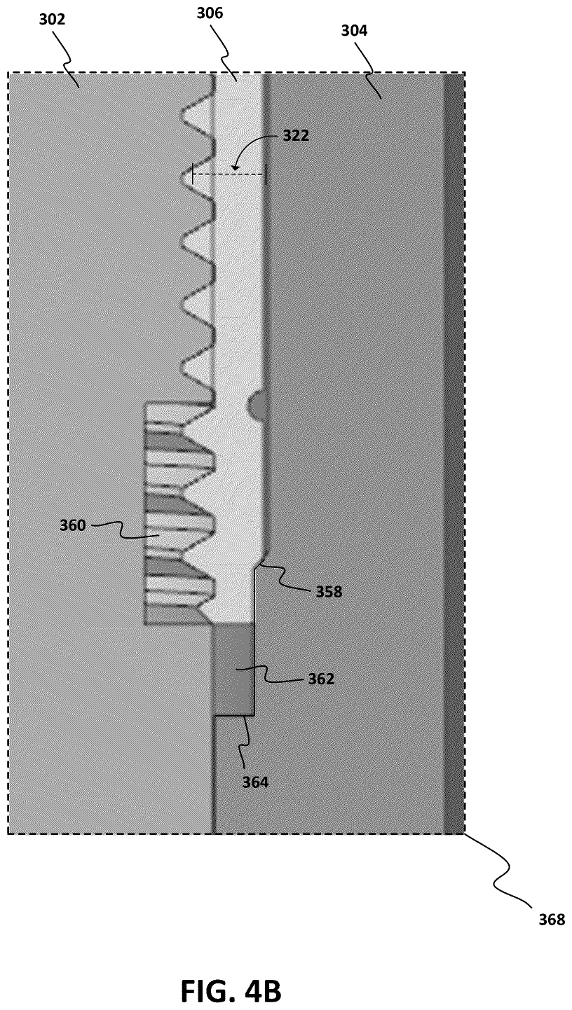

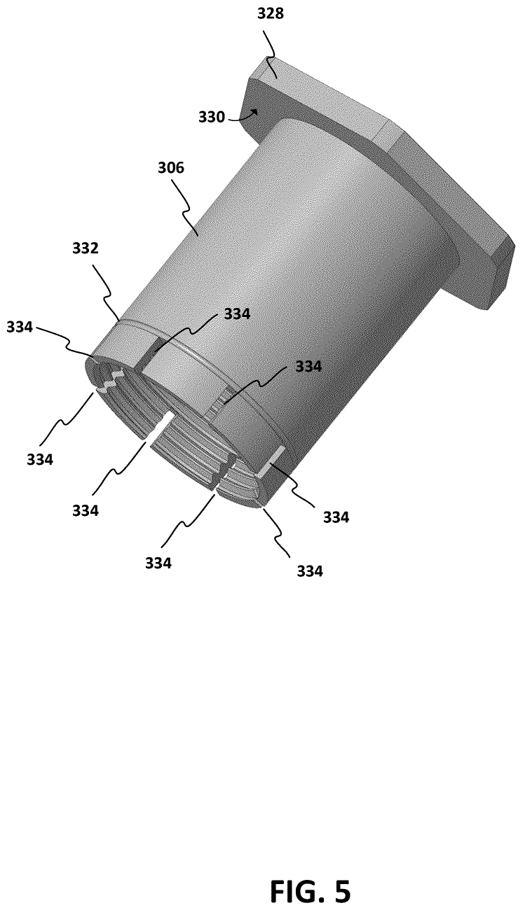

With respect to FIG. 4A, damper piston assembly 350 depicts a piston 305 with an alternative embodiment with respect to the piston 304 of FIGS. 3A and 4A. The piston 305 can be formed with an opening to allow the shaft 302 to pass through where the opening has three different diameters. The first diameter 352 can be referred to as a counterbore and is formed such that a gap is left between the counterbore and the shaft 302 where the thickness 322 of the self-crimping nut 306 can fill the gap. The second diameter 354 is a diameter between the first diameter 352 and the third diameter 356. The third diameter 356 can be the same diameter as the diameter of the shaft 302. A chamfer 358 can be formed between the first diameter 352 and the second diameter 354. The chamfer 358 can be angled with respect to the axial length of the counterbore and the axial length of the self-crimping nut 306. The difference in length between the first diameter 352 and the second diameter 354 can be less than the distance of the thickness 322. This also means the thickness of the chamfer 358 is less than the thickness 322 of the self-crimping nut 306. This particular embodiment is different than the chamfer 318 of FIGS. 4A and 5 which is depicted as being the same thickness as the thickness 322 of the self-crimping nut 306.

The damper piston assembly 350 depicts the self-crimping nut 306 as being fastened past the chamfer 358. In this embodiment, the chamfer 358 has deformed a crimp portion 360 of the self-crimping nut 306 into the threads of the shaft 302. The difference between the second diameter 354 and the third diameter 356 has been depicted to form a space 362. In one embodiment, with the chamfer 358 that has a thickness smaller than the thickness 322 combined the space 362, the self-crimping nut 306 can be fastened to a variable height such that the distal end of the self-crimping nut 306 can be fastened to end at the chamfer 358, end at the bottom surface 364 of the space 362, or can end anywhere between the chamfer 358 and the bottom surface 364 within the space 362. This variable height embodiment also can allow for the distance 366 to be variable. The distance 366 can be the distance between the surface 330 of the self-crimping nut 306 and the surface 312 of the piston 305. With distance 366 variable in length, the damper piston assembly can accommodate different sizes of shim stacks that possibly have different component parts with different sizes. The different sizes of shim stacks with the variable distance 366 can allow for different amounts of pre load to be set for the damper piston assembly.

Window 368 is depicted in FIG. 4A. FIG. 4B depicts an enlarged view of distance 366 of FIG. 4A. The enlarged view clearly depicts the chamfer 358 that is not the full thickness of thickness 322 of the self-crimping nut 306. The enlarged view also depicts the crimp portion 360 and the space 362.

With respect to FIG. 5 that depicts a three dimensional view of the self-crimping nut 306. The third portion 328 of the self-crimping nut 306 is depicted as have a hexagonal shape to be employed with a compatible fastener such as a wrench or a socket wrench. The relief portion 332 is also depicted as a groove that extends along the circumference of the outer diameter of the self-crimping nut 306. The relief portion 332 can be closer to the distal end of the self-crimping nut 306 than the surface 330 or proximal end of the self-crimping nut 306.

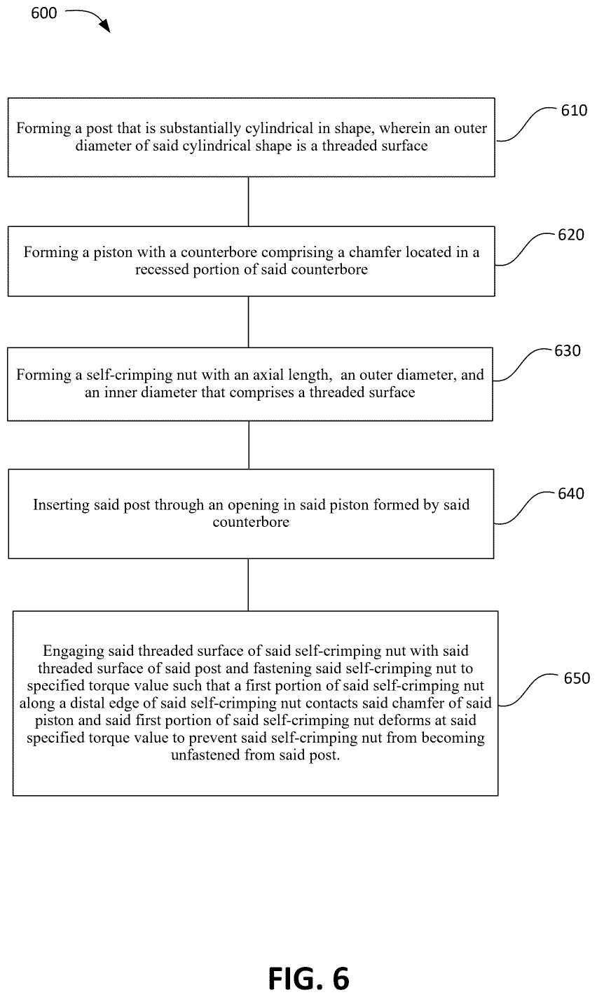

The self-crimping nut 306 in FIG. 6 also depicts optional relief portions 334. The optional relief portions 334 are depicted as having eight openings in the self-crimping nut 306. The optional relief portions 334 can include any different number of openings including eight openings. The optional relief portions 334 can create openings that begin at the proximal end of the self-crimping nut 306 and extend along the axial length of the self-crimping nut 306. A portion of the self-crimping nut 306 remains as a flange between each of the optional relief portions 334. The self-crimping nut 306 can include both a relief portion 332 and the optional relief portions 334. Alternatively, the self-crimping nut 306 can include the optional relief portions 334 without the relief portion 332. The openings formed by the optional relief portions 334 can extend to the relief portion 332. The openings formed by the optional relief portions 334 can stop short of reaching the relief portion 332 or can extend past the relief portion 332.

The flange or portion of the self-crimping nut 306 left in between the optional relief portions 334 can allow the self-crimping nut 306 to more easily deform and crimp upon installation to a specified torque value after contacting the chamfer of a piston as compared to an embodiment without the optional relief portions 334. A self-crimping nut 306 with the optional relief portions 334 can be referred to a castle shape or a castle nut. The optional relief portions 334 can also be referred to as a plurality of relief portions and can be substantially parallel to the axial length of the self-crimping nut 306.

FIG. 6 is a flowchart illustrating an example method 600 of manufacturing a damper piston assembly. The method includes forming, at step 610, a shaft that is substantially cylindrical in shape, wherein an outer diameter of the cylindrical shape is a threaded surface. The method further includes forming, at step 620, a piston with a counterbore comprising a chamfer located in a recessed portion of the counterbore. The method further includes forming, at step 630, a self-crimping nut with an axial length, an outer diameter, and an inner diameter that comprises a threaded surface. The method further includes inserting, at step 640, the shaft through an opening in the piston formed by the counterbore. The method further includes engaging, at step 650, the threaded surface of the self-crimping nut with the threaded surface of the shaft and fastening the self-crimping nut to specified torque value such that a first portion of the self-crimping nut along a distal edge of the self-crimping nut contacts the chamfer of the piston and the first portion of the self-crimping nut deforms at the specified torque value to prevent the self-crimping nut from becoming unfastened from the shaft.

In one embodiment, the self-crimping nut can be formed with a relief portion and the self-crimping nut deforms, at least in part, at the relief portion after the first portion of the self-crimping nut contacts the chamfer of the piston.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

The foregoing Description of Embodiments is not intended to be exhaustive or to limit the embodiments to the precise form described. Instead, The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims and their equivalents.

What is claimed is:

1. A damper apparatus, comprising:
a piston with a counterbore comprising a chamfer located in a recessed portion of said counterbore; and
a self-crimping nut comprising:
an axial length, wherein said chamfer is at an angle relative to said axial length,
an outer diameter wherein a portion of said outer diameter engages with said counterbore of said piston,
an inner diameter that comprises a threaded surface to fasten said self-crimping nut to said damper apparatus,
a first portion along a distal edge of said axial length that is configured to contact said chamfer of said piston and deform when fastened to said damper apparatus at a specified torque value to prevent said self-crimping nut from becoming unfastened, and
a second portion including said proximal edge of said self-crimping nut configured to extend beyond said counterbore of said piston.

2. The damper apparatus of claim 1, further comprising:
a relief portion formed in said self-crimping nut, wherein said self-crimping nut has a thickness along said axial length, said relief portion is a groove that is formed along said outer circumference of said self-crimping nut and is substantially perpendicular to said axial length, said groove forms a second thickness in said self-crimping nut that is thinner than said thickness of said self-crimping nut, and said self-crimping nut is configured to deform at said relief portion after said self-crimping nut engages said chamfer of said piston.

3. The damper apparatus of claim 1, further comprising:
a plurality of relief portions formed in said self-crimping nut, wherein said plurality of relief portions form openings in said self-crimping nut substantially parallel to said axial length and extend from an edge of said self-crimping nut and terminate in self-crimping nut, and portions of said self-crimping nut between said plurality of relief portions are configured to deform after said self-crimping nut engages said chamfer of said piston.

4. The damper apparatus of claim 1, wherein said self-crimping nut has a thickness, and wherein said chamfer is formed to engage an entire thickness of said self-crimping nut.

5. The damper apparatus of claim 1, further comprising: wherein said self-crimping nut has a thickness, and wherein said chamfer is formed to engage a partial thickness of said self-crimping nut, and said first portion of said self-crimping nut is allowed to pass said chamfer after said first portion has deformed to a variable depth within said counterbore of said piston.

6. The damper apparatus of claim 1, wherein a third portion of said self-crimping nut is located at said proximal edge of said self-crimping nut and extends laterally away from said axial length of said self-crimping nut such that a cross-section of said self-crimping nut forms a T shape, wherein a surface of said third portion of said self-crimping nut is substantially perpendicular to said axial length and faces a surface of said piston.

7. The damper apparatus of claim 6, further comprising:
a shim stack located between said surface of said third portions of said self-crimping nut and said piston and is configured to set a preload of said shim stack dependent upon said specified torque value.

8. The damper apparatus of claim 1, wherein said specified torque value is dependent upon a hardness of said material that said self-crimping nut is composed of.

9. The damper apparatus of claim 1, wherein said self-crimping nut is removeable from said damper apparatus after said self-crimping nut has been deformed at said specified torque value.

10. A damper piston assembly, comprising:
a shaft that is substantially cylindrical in shape, wherein an outer diameter of said cylindrical shape is a threaded surface;
a piston with a counterbore comprising a chamfer located in a recessed portion of said counterbore, said shaft extending through an opening formed by said counterbore;
a self-crimping nut comprising:
an axial length, wherein said chamfer is at an angle relative to said axial length,
an outer diameter wherein a portion of said outer diameter engages with said counterbore of said piston,
an inner diameter that comprises a threaded surface to fasten said self-crimping nut to engage with said threaded surface of said shaft,
a first portion along a distal edge of said axial length that is configured to contact said chamfer of said piston and deform when fastened to said damper apparatus at a specified torque value to prevent said self-crimping nut from becoming unfastened, wherein said second portion is located between said shaft and said piston after said damper piston assembly has been assembled, and
a second portion including said proximal edge of said self-crimping nut configured to extend beyond said counterbore of said piston; and
a shim stack located between said piston and said self-crimping nut that is configured to set a preload of said shim stack.

11. The damper piston assembly of claim 10, further comprising:
a relief portion formed in said self-crimping nut, wherein said self-crimping nut has a thickness along said axial length, said relief portion is a groove that is formed along said outer circumference of said self-crimping nut and is substantially perpendicular to said axial length, said groove forms a second thickness in said self-crimping nut that is thinner than said thickness of said self-crimping nut, and said self-crimping nut is configured to deform at said relief portion after said self-crimping nut engages said chamfer of said piston.

12. The damper piston assembly of claim 10, further comprising:
a plurality of relief portions formed in said self-crimping nut, wherein said plurality of relief portions form openings in said self-crimping nut substantially parallel to said axial length and extend from an edge of said self-crimping nut and terminate in self-crimping nut, and portions of said self-crimping nut between said plurality of relief portions are configured to deform after said self-crimping nut engages said chamfer of said piston.

13. The damper piston assembly of claim 10, wherein said self-crimping nut has a thickness, and wherein said chamfer is formed to engage an entire thickness of said self-crimping nut.

14. The damper piston assembly of claim 10, further comprising: wherein said self-crimping nut has a thickness, and wherein said chamfer is formed to engage a partial thickness of said self-crimping nut, and said first portion of said self-crimping nut is allowed to pass said chamfer after said first portion has deformed to a variable depth within said counterbore of said piston.

15. The damper piston assembly of claim 10, wherein a third portion of said self-crimping nut is located at said proximal edge of said self-crimping nut and extends laterally away from said axial length of said self-crimping nut such that a cross-section of said self-crimping nut forms a T shape, wherein a surface of said third portion of said self-crimping nut is substantially perpendicular to said axial length and faces a surface of said piston.

16. The damper piston assembly of claim 15, wherein said shim stack is located between said surface of said third portions of said self-crimping nut and said piston.

17. The damper piston assembly of claim 10, wherein said specified torque value is dependent upon a hardness of said material that said self-crimping nut is composed of.

18. The damper piston assembly of claim 10, wherein said self-crimping nut is removeable from said damper apparatus after said self-crimping nut has been deformed at said specified torque value.

19. A method of manufacturing a damper piston assembly, comprising:
forming a shaft that is substantially cylindrical in shape, wherein an outer diameter of said cylindrical shape is a threaded surface;
forming a piston with a counterbore comprising a chamfer located in a recessed portion of said counterbore,
forming a self-crimping nut with an axial length, an outer diameter, and an inner diameter that comprises a threaded surface;
inserting said shaft through an opening in said piston formed by said counterbore;
engaging said threaded surface of said self-crimping nut with said threaded surface of said shaft and fastening said self-crimping nut to specified torque value such that a first portion of said self-crimping nut along a distal edge of said self-crimping nut contacts said chamfer of said piston and said first portion of said self-crimping nut deforms at said specified torque value to prevent said self-crimping nut from becoming unfastened from said shaft.

20. The method of manufacturing of claim 19, wherein said self-crimping nut is formed with a relief portion and said self-crimping nut deforms, at least in part, at said relief portion after said first portion of said self-crimping nut contacts said chamfer of said piston.
